(19) United States
(12) Patent Application Publication
(10) Pub. No.: US 2025/0333157 A1
(43) Pub. Date: Oct. 30, 2025

(54) AIRCRAFT WINDOW WITH REDUCED WEIGHT BUT THE SAME RIGIDITY

(71) Applicant: SAINT-GOBAIN GLASS FRANCE, COURBEVOIE (FR)

(72) Inventors: Michel ROUBY, BRAY EN VAL (FR); Adrien DUFFOUR, SAINT-CYR EN VAL (FR)

(21) Appl. No.: 18/696,881

(22) PCT Filed: Jul. 11, 2022
(86) PCT No.: PCT/FR2022/051396

§ 371 Date: Sep. 17, 2024

(30) Foreign Application Priority Data
Sep. 30, 2021 (FR) 2110318

(51) Int. Cl. B64C 1/14

(52) U.S. Cl. CPC B64C 1/1492

(57) ABSTRACT

An aircraft window includes an inner panel and an outer panel which are separated by a layer of air and by an installation seal into which a peripheral portion of the window is set, the inner panel including a first, outer pane of glass and a second, inner pane of glass, each having a thickness from 0.1 mm to 3 mm and being bonded to one another by a first adhesive interlayer with a thickness from 50 μm to 2 mm, and/or the outer panel including of a first, outer sheet of transparent structural polymer material with a thickness from 1.5 mm to 100 mm bonded to a third, inner pane of glass with a thickness from 0.1 mm to 30 mm by a second adhesive interlayer with a thickness from 50 μm to 2 mm.

The invention relates to glazed units for fixed-wing aircraft (airplanes) or rotary-wing aircraft (helicopters), or fixed-and rotary-wing aircraft. This generic designation refers to vehicles as sold by the Bell-Boeing Company under the name V-22 Ospey, or by the company Agusta Westland under the name AW609. It in particular refers to cabin windows generally composed of two biaxially stretched poly(methyl methacrylate) (PMMA) panels separated by a layer of air. These two panels are held by a peripheral seal attached or molded around the edge of the two panels while maintaining a gap that defines the layer of air.

Airplane window panels are sized by the resistance to the differential pressure of the outer panel (deflection and breaking). As regards the inner panel, it is sized only by its mechanical strength in the event of the outer panel breaking. This strength is related to the risk of the panel being removed from the seal wherein it is housed, by deformation or by the intrinsic breaking strength of its constituent material (as a general rule, cross-linked biaxially stretched PMMA).

The inventors aimed to provide an inner panel and an outer panel which are lighter while maintaining their required mechanical properties. The two panels can be replaced individually, independently of one another, or on the contrary, jointly. The inventors have devised to replace at least part of the PMMA with glass which, with an equivalent rigidity, is thinner but also lighter. The mass gain with an equivalent rigidity is greater when the thickness of glass is greater.

Thus, the inner panel made of PMMA can advantageously be replaced by a laminated thin glass panel.

For the same purpose, the outer panel made of PMMA can advantageously be replaced by a laminated thin outer sheet of PMMA with an inner glass, each with a selected thickness.

The targeted result is now obtained by means of the invention which, consequently, relates to an aircraft window composed of an inner panel and an outer panel which are separated by a layer of air by means of an installation seal into which a peripheral portion of the window is set, characterized in that the inner panel consists of a first, outer pane of glass and a second, inner pane of glass, each having a thickness from 0.1 mm to 3 mm, preferably from 0.5 mm to 1.2 mm, and being bonded to one another by a first adhesive interlayer with a thickness from 50 μm to 2 mm, preferably from 250 μm to 1.3 mm, and/or the outer panel consisting of a first, outer sheet of transparent structural polymer material with a thickness from 1.5 mm to 100 mm, preferably from 3 to 12 mm bonded to a third, inner pane of glass with a thickness from 0.1 mm to 30 mm, preferably from 0.5 to 2.7 mm, by means of a second adhesive interlayer with a thickness from 50 μm to 2 mm, preferably at least equal to 250 μm.

Within the meaning of the invention, the terms “inner” and “outer” refer to the inner volume of the aircraft and to the outside atmosphere. The window can be curved, and any person skilled in the art recognizes, at least in the form of the installation seal, the face of the window intended to be in contact with the outside atmosphere and the face of the window intended to be in contact with the inner volume of the aircraft.

Furthermore, “sheet of transparent structural polymer material” is understood to mean a sheet itself capable of forming a monolithic glazed unit, ensuring the mechanical strength thereof, in particular, and having an elastic modulus at least equal to 1500 MPa for example, unlike an adhesive interlayer, for example.

Particularly preferably according to the invention, the inner panel is made of laminated glass and the outer panel of thin laminated structural polymer on its inner face with respect to a glass. However, according to other variants of the invention, only the inner panel is made of laminated glass, or only the outer panel is made of thin laminated structural polymer on its inner face with respect to a glass.

Thus, according to a first variant, the outer panel consists of a single sheet of transparent structural polymer material with a thickness from 3 mm to 100 mm, preferably from 6 mm to 15 mm.

According to a second variant, the outer panel consists of a fourth outer pane of glass with a thickness from 0.2 mm to 2.6 mm, preferably from 1.6 mm to 2.4 mm, bonded to a fifth inner pane of glass with a thickness from 0.2 mm to 2.1 mm, preferably from 0.4 mm to 1.9 mm, by means of a third adhesive interlayer.

According to a third variant, the inner panel consists of a single sheet of transparent structural polymer material with a thickness from 2 to 100, preferably from 2.5 to 12 mm, clear or dyed, uniformly or not.

Preferably, the window comprises a layer or a stack of layers for sun protection, low emissivity, a WiFi antenna, a heating/defogging coating, an electromagnetic shield and/or a screen and/or display.

The sun protection function consists in reflecting the solar radiation in order to limit the heating inside the vehicle; mention may be made of a silver bilayer or silver trilayer stack. The low emissivity function consists in reflecting certain infrared radiation in order to keep heat inside the vehicle, limiting the sensation of cold when a passenger's head, in particular, approaches the inner face of the window during flight. The sun protection function and the low emissivity function are thermal control functions.

A WiFi antenna can be etched in an electrically conductive layer, or electrically conductive wire, in particular inserted into an adhesive interlayer.

A heating/defogging coating is an electrically conductive heating coating, such as a Transparent Conductive Oxide (TCO) of the Indium Tin Oxide (ITO) type, or SnO₂:F. The heating/defogging coating is necessarily close, in the thickness of the window structure, to the inner face thereof, whereupon the fog is likely to form, in order to be able to remove this fog by heating.

Electromagnetic shielding is a screen with respect to electromagnetic waves, preventing the latter from entering and exiting the aircraft. It is also called EMP (Electro-Magnetic Pulse) shielding. If the layer constituting EMP shielding is located on the inner face of the outer panel or on the inner or outer face of the inner panel, the installation seal will necessarily be conductive and in electrically conductive contact with the structure of the aircraft (cockpit, etc.).

A screen and a display refer here to the display of information related to the flight, or general information, or even animated images, videos, etc. The technical means and structures may be similar to those of a Head-Up Display (HUD) on an automotive windshield, or a television screen.

According to one advantageous feature, the outer face of the outer panel is coated with a hydrophobic or hydrophilic layer, and/or the inner face of the inner panel is coated with a hydrophilic layer. The hydrophobic function of a surface is carried out by its high contact angle with the liquid, in particular with water, for example at least equal to 90°, which is manifested by a sliding of the water in the form of drops, under their own weight or under the aerodynamic effect resulting from the speed of the aircraft. Well known hydrophobic agents are for example fluorinated silanes. The hydrophilic function on the contrary is carried out by a low water contact angle surface, less than 90°, or even no more than 20°. Instead of breaking into drops, the water on the contrary forms a uniform transparent film. Such a surface in particular prevents the formation of fog that hinders vision through a glazed unit. (The fog can form on the cold surface of a glazed unit in contact with a relatively hot volume, such as the inside of a vehicle.) Known hydrophilic agents are silica, photocatalytic titanium dioxide (crystallized in rutile form), hydrophilic polymers such as poly(vinyl alcohol) (PVAL), polyethylene glycol (PEG), acrylic such as polyacrylamide (PAM), polyvinylpyrrolidone (PVP), etc.

In a first preferred embodiment, at least one of the two faces of at least one of the first outer pane of glass and the second inner pane of glass, preferably the inner face of the first outer pane of glass and/or the outer face of the second inner pane of glass, and/or the inner face of the first outer sheet of transparent structural polymer material and/or the at least one of the two faces of the third inner pane of glass is (are) coated with a thermal control layer or a stack of thermal control layers.

In a second preferred embodiment, at least one of the sheets of transparent structural polymer material is (are) made of a material with a thermal control property, in particular solar control.

In a third preferred embodiment, the first and/or the second adhesive interlayer(s) is (are) made of a material with a thermal control property and/or a film with a thermal control property is inserted into the first and/or the second adhesive interlayer(s). Each of these films comprises molecules and/or particles absorbing and/or reflecting the infrared radiation and/or a superposition of layers constituting a Bragg mirror. The base of the film (part of the film supporting the thermal control function) may consist of poly(ethylene terephthalate) (PET) or equivalent. An example of a transparent thermal control film is commercially available from 3M under the trade name “Ultra-Clear Solar film” (UCSF), which is a multi-layer film reflecting solar radiation (energy) without affecting visible light transmission. This film, which is neutral in color, can be sandwiched between two adhesive interlayers such as PVB, EVA, TPU, an ionomer resin such as SentryGlas® sold by Kuraray, cast interlayer resin.

If the layer, the stack of layers, the thermal control material or film is on the inner panel (first outer pane of glass, second inner pane of glass, first adhesive interlayer), it is rather a layer, a stack, a low-emissivity material or film, in particular limiting the sensation of cold when an occupant's or passenger's head approaches the inner face of the window, while if the layer, the stack of layers, the thermal control material or film is on the outer panel (first outer sheet of transparent structural polymer material, third inner pane of glass, second adhesive interlayer), it is rather a layer, a stack, anti-solar material or film.

Preferably, each pane of glass is made of soda-lime glass, aluminosilicate, borosilicate or equivalent, optionally hardened, thermally tempered and preferably chemically reinforced.

Preferably, each sheet of transparent structural polymer material comprises a poly(methyl methacrylate) (PMMA), a polycarbonate (PC), a polyurea/urethane as sold by PPG under the trade name Opticor® or under reference PSS-1000, or any transparent polymer material having a Young's modulus at least equal to 1500 MPa, alone or as mixtures or copolymers of several of them.

Preferably, each adhesive interlayer is chosen from a polyvinyl butyral (PVB), optionally with an acoustic damping property, a thermoplastic polyurethane (TPU), an ethylene-vinyl acetate copolymer (EVA), an ionomer glass or a cast interlayer resin.

Preferably, the installation seal is pierced by a channel placing the inside atmosphere of the aircraft in communication with the layer of air. This measure aims to equalize the air pressure between the aircraft cabin and the layer of air of the window, particularly when the cabin is pressurized. Because the inner panel is made of laminated glass, it is preferable not to pierce the through channel therein, unlike the inner panel made of conventional monolithic PMMA.

The invention is illustrated by the appended drawings, wherein

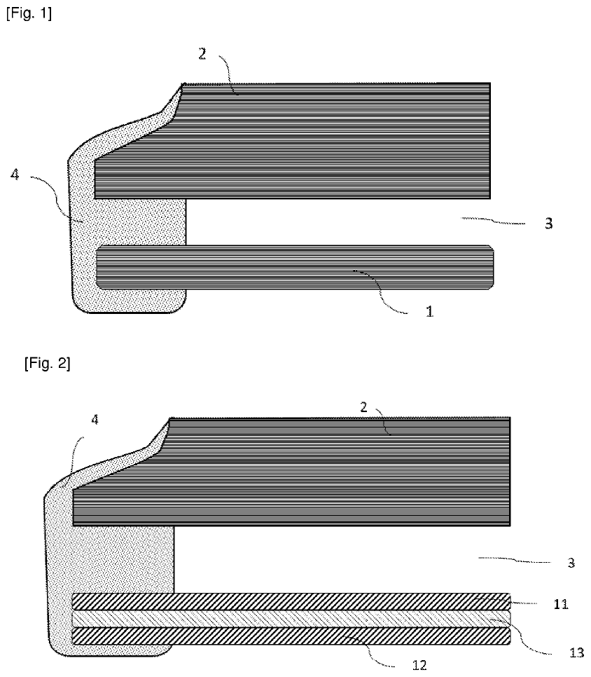

FIG. 1 is a diagrammatic cross sectional view of a window of the state of the art.

FIG. 2 is a diagrammatic cross sectional representation of a main first embodiment of the window of the invention.

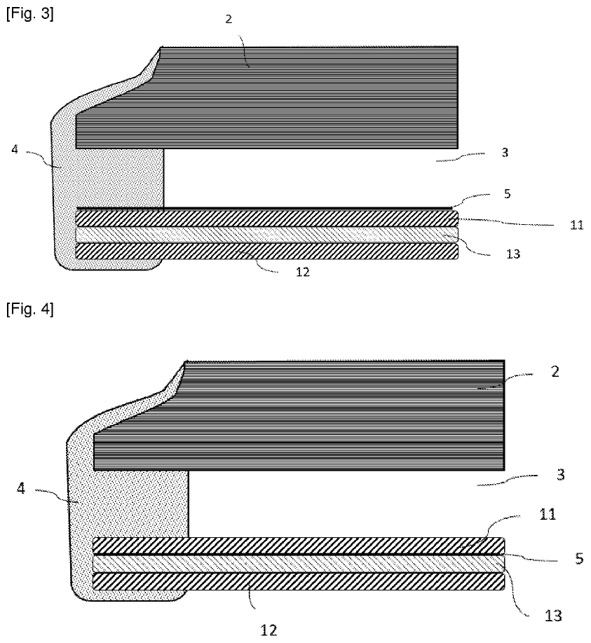

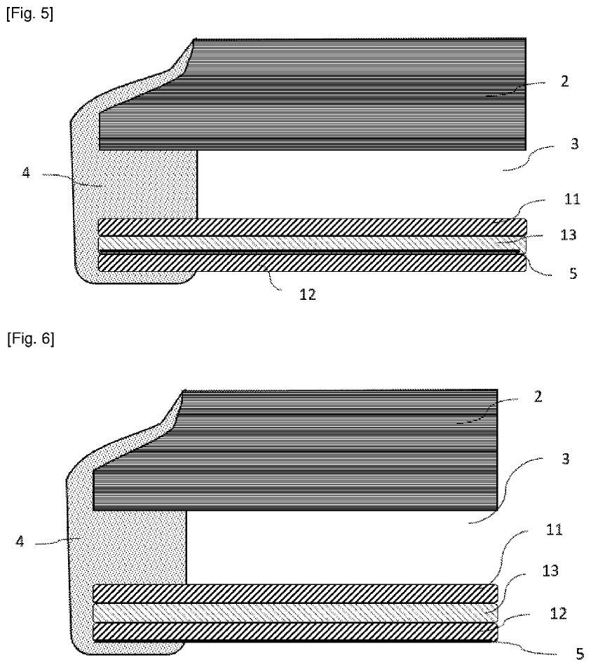

FIG. 3, FIG. 4, FIG. 5 and FIG. 6 depict four variants of the first main embodiment of FIG. 2 wherein the panes of glass of the inner panel are coated with a thermal control layer or a stack of thermal control layers.

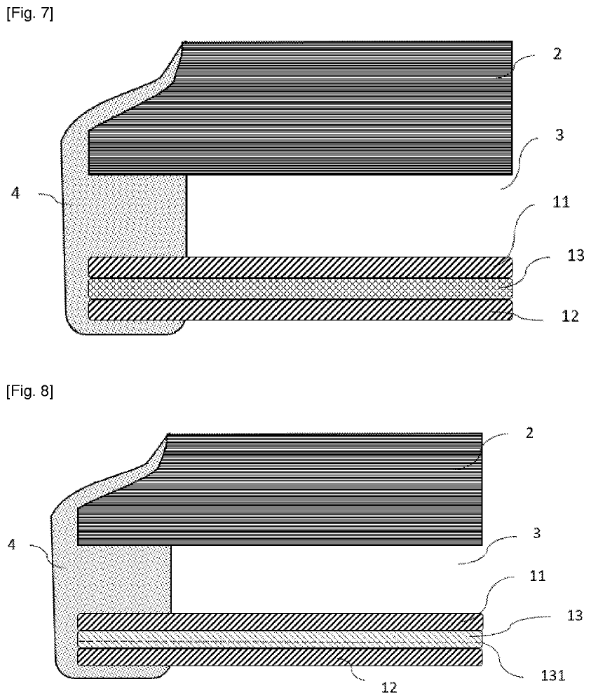

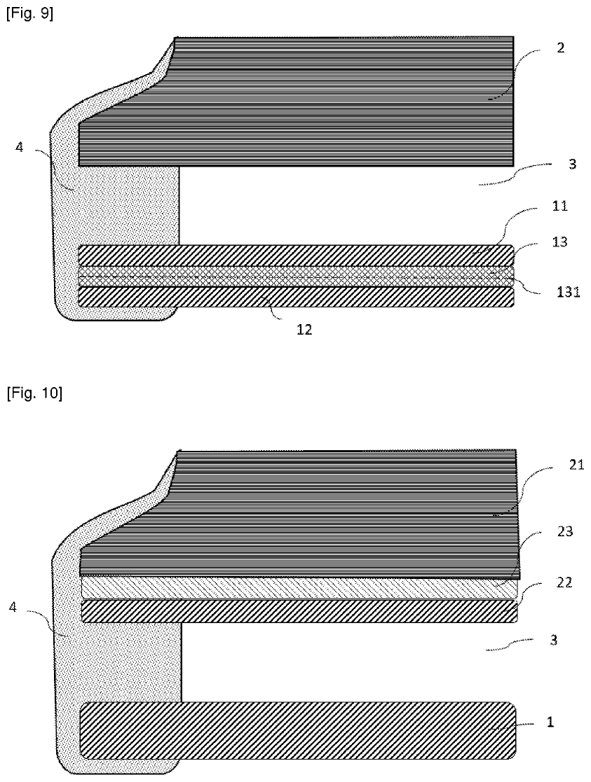

FIG. 7, FIG. 8 and FIG. 9 depict, diagrammatically in cross section, three variants of the first main embodiment of FIG. 2 wherein the thermal control function is comprised in the adhesive interlayer of the inner panel.

FIG. 10 is a diagrammatic cross sectional representation of a main second embodiment of the window of the invention.

In FIG. 1, a conventional window comprises an inner panel 1 and a monolithic outer panel 2 made of PMMA, a peripheral portion of which is set in an installation seal 4 made of silicone or the like, which holds them parallel at a certain distance from one another, defining a layer of air 3.

In accordance with the invention, the window of FIG. 2 differs from that of FIG. 1 by the inner panel consisting of two panes of glass 11 and 12 of 0.55 mm thick bonded by a layer 13 of 0.76 mm of PVB. The rigidity or stiffness M (Nmm) of this laminated glazed unit is slightly greater than that of a monolithic PMMA panel with a thickness of 4 mm. Each pane of glass is made of soda-lime glass, aluminosilicate or borosilicate glass, and is chemically reinforced. The surface density of the inner panel of laminated glass is 3.6 kg/m², less than that of a monolithic PMMA panel with a thickness of 4 mm (4.8 kg/m²). The installation seal 4 comprises a pressure equalizing hole (not shown) on either side of the laminated inner panel.

In FIG. 3, a low-emissivity layer or a stack of low-emissivity layers 5 coats the outer face of the outer pane of glass 11 of the inner panel, so as to keep the heat inside the aircraft.

In FIG. 4 low-emissivity layer or a stack of low-emissivity layers 5 coats the inner face of the outer pane of glass 11 of the inner panel.

In FIG. 5, a low-emissivity layer or a stack of low-emissivity layers 5 coats the outer face of the inner pane of glass 12 of the inner panel.

In FIG. 6, a low-emissivity layer or a stack of low-emissivity layers 5 coats the inner face of the inner pane of glass 12 of the inner panel.

In FIG. 7, the low-emissivity function is provided by the nature of the adhesive layer 13 (PVB or the like), which comprises infrared reflective particles.

In FIG. 8, the low-emissivity function is provided by inserting, into the adhesive layer 13 (PVB or the like), a PET film 131 supporting a low-emissivity layer or a stack of low-emissivity layers or a Bragg mirror on one or both of its faces.

FIG. 9 shows a window wherein the low-emissivity means of FIGS. 7 and 8 are cumulatively present.

In accordance with the second main embodiment of the window of the invention shown in FIG. 10, the outer panel consists of a thin sheet of PMMA 21 with a thickness of less than 12 to 4 mm bonded to a chemically reinforced pane of glass 22 with a thickness of 2.7 mm by means of a lamination interlayer 23 with a thickness of 0.76 mm (TPU or the like). For this specific example, other thicknesses of the glass/PMMA pair are possible, respectively ( 2.7/4; 2/5.75; 1.5/7.3; 1.2/8.25; 1/8.9; 0.7/10; 0.5:10.7) mm, but with decreasing gains in mass relative to the monolithic PMMA panel of 12 mm. The mass gain with an equivalent rigidity is greater when the thickness of glass is greater. The inner panel consists of a monolithic sheet of PMMA 1 with a thickness of 3 to 6 mm. A solar-protection layer or a stack of solar-protection layers (not shown) is capable of coating the inner face of the sheet of PMMA 21, or the outer face or the inner face of the pane of glass 22. The solar-protection function may conversely be carried out by the TPU layer 23, like the low-emissivity function by the previously disclosed PVB layer 13 (nature of the adhesive interlayer material wherein particles are inserted, for example, insertion of a PET film supporting a solar-control layer or a stack of solar-control layers).

1. An aircraft window composed of an inner panel and an outer panel which are separated by a layer of air by an installation seal into which a peripheral portion of the window is set, wherein the inner panel consists of a first, outer pane of glass and a second, inner pane of glass, each having a thickness from 0.1 mm to 3 mm, and being bonded to one another by a first adhesive interlayer with a thickness from 50 μm to 2 mm, and/or the outer panel consisting of a first, outer sheet of transparent structural polymer material with a thickness from 1.5 mm to 100 mm bonded to a third, inner pane of glass with a thickness from 0.1 mm to 30 mm by a second adhesive interlayer with a thickness from 50 μm to 2 mm.

2. The aircraft window according to claim 1, wherein the outer panel consists of a single sheet of transparent structural polymer material with a thickness from 3 mm to 100 mm.

3. The window according to claim 1, wherein the outer panel consists of a fourth outer pane of glass with a thickness from 0.2 mm to 2.6 mm bonded to a fifth inner pane of glass with a thickness from 0.2 mm to 2.1 mm by a third adhesive interlayer.

4. The aircraft window according to claim 1, wherein the inner panel consists of a single sheet of transparent structural polymer material with a thickness from 2 to 100 clear or dyed, uniformly or not.

5. The window according to claim 1, further comprising a layer or a stack of layers for sun protection, low emissivity, a WiFi antenna, a heating/defogging coating, an electromagnetic shield and/or a screen and/or display.

6. The window according to claim 1, wherein the outer face of the outer panel is coated with a hydrophobic or hydrophilic layer, and/or the inner face of the inner panel is coated with a hydrophilic layer.

7. The window according to claim 1, wherein at least one of the two faces of at least one of the first outer pane of glass and the second inner pane of glass is coated with a thermal control layer or a stack of thermal control layers.

8. The window according to claim 2, wherein at least one of the sheets of transparent structural polymer material consist(s) of a material with a thermal control property.

9. The window according to claim 1, wherein the first and/or the second adhesive interlayer(s) consist of a material with a thermal control property and/or a film with a thermal control property is inserted into the first and/or the second adhesive interlayer(s).

10. The window according to claim 9, wherein each film comprises molecules and/or particles absorbing and/or reflecting the infrared radiation and/or a superposition of layers constituting a Bragg mirror.

11. The window according to claim 3, wherein each pane of glass is made of soda-lime glass, aluminosilicate, borosilicate or equivalent, optionally hardened, thermally tempered and optionally chemically reinforced.

12. The window according to claim 2, wherein each sheet of transparent structural polymer material comprises a poly(methyl methacrylate) (PMMA), a polycarbonate (PC), a polyurea/urethane, or any transparent polymer material having a Young's modulus at least equal to 1500 MPa, alone or as mixtures or copolymers of several of them.

13. The window according to claim 3, wherein each adhesive interlayer is chosen from a polyvinyl butyral (PVB), optionally with an acoustic damping property, a thermoplastic polyurethane (TPU), an ethylene-vinyl acetate copolymer (EVA), an ionomer glass or a cast interlayer resin.

14. The window according to claim 1, wherein the installation seal is pierced by a channel placing the inside atmosphere of the aircraft in communication with the layer of air.

15. The window according to claim 1, wherein the first, outer pane of glass and the second, inner pane of glass of the inner panel each have a thickness from 0.5 mm to 1.2 mm, wherein the first adhesive interlayer has a thickness from 250 μm to 1.3 mm, wherein the first, outer sheet of transparent structural polymer material has a thickness from 3 mm to 12 mm, and wherein the third, inner pane of glass has a thickness from 0.5 mm to 2.7 mm.

16. The window according to claim 2, wherein the thickness of the outer panel is from 6 mm to 15 mm.

17. The window according to claim 3, wherein the fourth outer pane of glass has a thickness from 1.6 mm to 2.4 mm, and wherein the fifth inner pane of glass has a thickness from 0.4 mm to 1.9 mm.

18. The window according to claim 4, wherein the thickness of the single sheet of transparent structural polymer material is from 2.5 to 12 mm.

19. The window according to claim 7, wherein the inner face of the first outer pane of glass and/or the outer face of the second inner pane of glass, and/or the inner face of the first outer sheet of transparent structural polymer material and/or the at least one of the two faces of the third inner pane of glass is/are coated with a thermal control layer or a stack of thermal control layers.
